(19) United States
(12) Patent Application Publication
(10) Pub. No.: US 2019/0158312 A1
(43) Pub. Date: May 23, 2019

(54) VoIP Countersurveillance System

(71) Applicant: David Junkin, Plano, TX (US)

(72) Inventors: David Junkin, Plano, TX (US); Chandranshu Rao, Frisco, TN (US)

(21) Appl. No.: 16/193,648

(22) Filed: Nov. 16, 2018

Related U.S. Application Data
(60) Provisional application No. 62/586,960, filed on Nov. 16, 2017.

(51) Int. Cl. H04L 12/46; H04M 7/00; G08B 5/36

(52) U.S. Cl. CPC H04L 12/4641; G08B 5/36; H04M 7/009; H04M 7/006

(57) ABSTRACT

A system for detecting undesirable data transfer is disclosed. An intermediary device is situated between and coupled to a voice over Internet telephone and a private branch exchange Ethernet port, and contains a processor, transceiver, and lighting indicator. When data is exchanged through the intermediary device while the telephone is not in use, the lighting indicator will alert the telephone's primary user that a potential security breach has occurred.

### CROSS-REFERENCE TO RELATED APPLICATION

This application claims priority to U.S. Provisional Patent Application Ser. No. 62/586,960 titled “VoIP Countersurveillance System,” filed Nov. 16, 2017, which is incorporated herein by reference.

### BACKGROUND OF THE INVENTION

The present invention is directed generally to a countersurveillance system, and more particularly to a novel system that is easy to deploy and use by a technically non-proficient individual, and which detects covert surveillance, such covert surveillance activity for example as exploits the transmission of audio or video communication from a Voice over Internet Protocol (VoIP) device using a virtual local area network (VLAN) enabled Ethernet communication network.

VoIP technology digitizes analog voice sound signals. Specifically, VoIP converts voice communications, as one would traditionally hear by telephone, into digital data packs that are transmitted over IP data networks such as enterprise networks or the Internet. A VoIP technology system may contain a server, gateway connecting internal architecture with Public Switched Telephone Networks (PSTN), software, and hardware such as computers and phones.

The basic process of a VoIP transmission includes digitzation of an analog signal, encoding, packetization, and transmission as IP packets over a packet switched network; and vice versa for decoding the signal and transmitting to a receiver in analog form. Various VoIP protocols include Session Initiation Protocol (SIP) for signaling, and Real-Time Transport Protocol (RTP) for media transmission. VoIP transmissions, or calls, can be made from computer to computer, computer to cell phone, smart phone to smart phone, etc. Targeted infiltrations over VoIP may include eavesdropping, connection hijacking, call fraud, and DoS attacks. The articles “Eavesdropping and Interception Security Hole and Its Solution over VoIP Service,” 2014 IEEE Global Conference on Wireless Computing and Networking, and “An Empirical Study of Security of VoIP System,” SAI Computing Conference 2016, incorporated herein in their entirety, describe in detail the methods and processes of malicious VoIP intrusions, or hacks.

The U.S. Department of Homeland Security's publication “4300A Sensitive Systems Handbook, Attachment Q5, Voice Over Internet Protocol (VOIP),” incorporated here in its entirety, surveys widespread VoIP security risks, including eavesdropping. Examples of countermeasures against eavesdropping include use of sophisticated firewalls and intrusion detection or prevention systems.

A VoIP security breach can result in an infiltrator, or hacker, making, receiving and transferring calls, playing recordings, uploading firmware, or simply engaging in spying. Through a combination of applications like Wireshark, VOMIT, Agnst or Oreka, VoIP telephone conversation data can be recorded and transferred to audio files for third party exploitation. A hacker may wish to make calls to his or her own pre-established premium phone line to essentially pay himself through use of an unsuspecting corporate employee's phone line. https://www.profwoodward.org/2016/02/are-you-only-one-using-your-voip-phone.html.

Commonly suggested personnel defenses against VoIP intrusions include using strong passwords and VLAN, and commonly updating firmware. Unfortunately, these remedial measures are largely ineffective strategies when stressed upon unsophisticated or apathetic employees, agents, representatives, students, and others with access to potentially sensitive business and technical information.

Many larger companies and organizations with internal security departments or external partners employ dedicated security specialists that can use available technologies to help identify security breaches that occur over Ethernet lines. However, as companies and organizations are increasingly “connected,” each employee or contractor may become a target of a hacker. While a select few companies may be able to implement redundant technologies at the level of each employee, and staff to monitor accordingly, most companies will not be able to afford dedicated security resources at the level of the individual. A technology is needed that will allow users of VLAN, regardless of sophistication, to identify a suspect event, such as an inadvertent or intentional unauthorized infiltration into organizational information.

The technical basis for VoIP communications and hardware are commonly known. U.S. Pat. No. 6,243,373 is a foundational VOIP patent generally proscribing the act of calling someone through a computer network, or with the aid of a computer network, as opposed to primarily through the public switched telephone network (PSTN).

U.S. Pat. No. 5,959,990 provides for a means of transferring data from multiple VLAN's while preserving associations of data frames to specific VLAN's.

U.S. Pat. No. 6,414,958 provides for a four-port Ethernet switch to pass a specific type of VLAN traffic to preclude the access of financial or other sensitive information among networked VLAN's.

Some consumer products are marketed for the detection of VoIP intrusions on individual VoIP devices. The SharkTap product by midBit Technologies, LLC, features two Ethernet ports on each side of a box that serves as an Ethernet link. The box features a third port, called a Testing Access Port (TAP), that allows for an engineer to duplicate the flow of information along the Ethernet line for investigation of irregular activity. The box employs port mirroring and is considered to be a category of SPAN or aggregating port whereby both network ports are mirrored to a single TAP. The SharkTap is effectively an active, as opposed to passive, linker that receives a packet in fully before transferring on along the line. Using the SharkTap, an individual may monitor in limited bandwidth situations whether packets are being transferred during computer idling, where traffic is originating or directed, and whether unauthorized sites are engaged. (www.midbittech.com). Limitations of the SharkTap include an inability to analyze network traffic or to differentiate specific packet types.

The Gig Zero Delay Tap by Net Optics is a passive quad-port box designed to allow for inputs and outputs along an Ethernet line, as well as to a monitoring system. While the Gig Zero Delay Tap does provide some storage capabilities to de-risk power interruptions, it does not differentiate among packet types nor does it provide a means of automated analysis.

The Throwing Star LAN Tap by Great Scott Gadgets is another passive Ethernet tap. It is limited to single direction monitoring and cannot monitor Gigabit transfers.

All of these systems are dependent upon staffed engineers who can set controls for the respective monitoring devices and run software such as Wireshark. Additionally, none of the systems actually combine nor suggest the combination of transceiver, processor, indicator, and storage device.

### BRIEF SUMMARY OF THE INVENTION

In a preferred embodiment of the present invention, an apparatus that can connect between a technological device and digital information network features a casing surrounding electronic and mechanical parts components, one or more USB ports, and one or more Ethernet ports.

### BRIEF DESCRIPTION OF DRAWINGS

FIG. 1 is a structural diagram of a countersurveillance system featuring an apparatus for identifying and signaling uninitiated VoIP traffic provided by an example of the present invention.

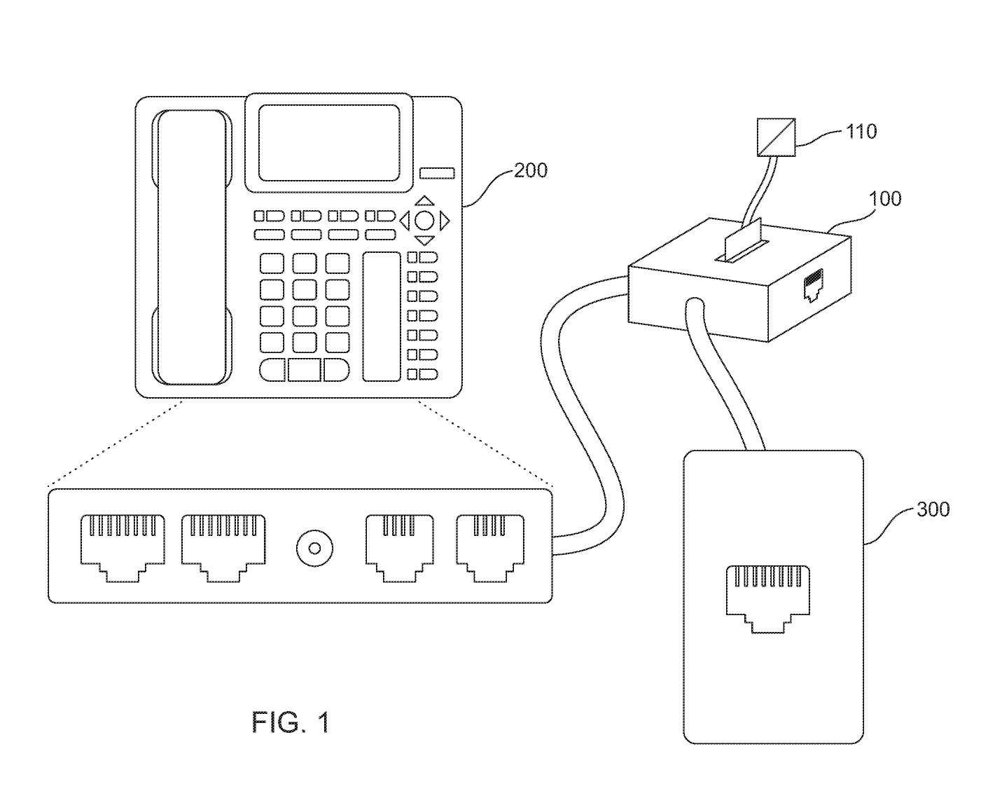

FIG. 2 is a schematic view illustrating the system and apparatus of FIG. 1.

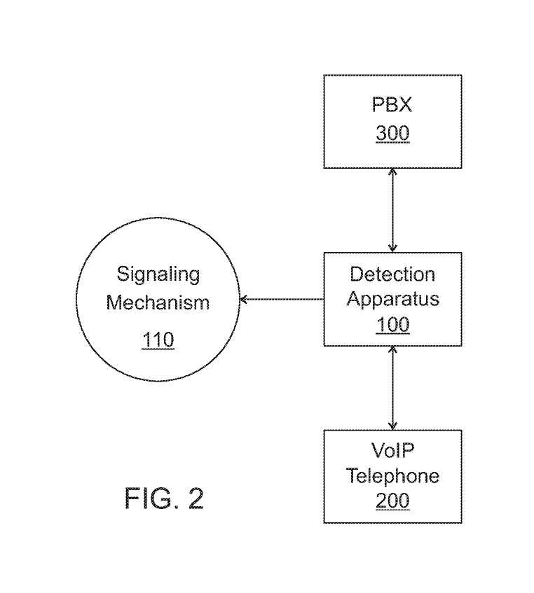

### DETAILED DESCRIPTION OF THE INVENTION

As used herein, “EoC” refers to the transmission of Ethernet frame data over coaxial cables. EoC is a favorable technology to use for broadband data transmission, e.g. over local area networks.

As used herein, “HDMI” refers to high-definition multimedia interface technology allowing digital audio and video data to be transferred between communications and computing devices.

As used herein, “PBX” refers to a private branch exchange. A PBX concerns a network of telephone communications devices within an organization that allows for each device to access a public switched telephone network, while also allowing two devices within the organization to exchange information, or connect, without having to access the public network.

As used herein, “PHY” refers to the Ethernet physical layer transistor, or a transceiver technology designed to transmit signal over a variety of media over long distances.

As used herein, “PSTN” refers to the public switched telephone network, or the global network of circuit-switched telephone technologies including but not limited to infrastructure such as telephone lines, fiber optic cables, microwave transmission links, cellular networks, and communication satellites.

As used herein, “RTP” refers to real-time transport protocol, or a data transfer standard that is the primary standard for audio/video transfer and streaming.

As used herein, “SIP” refers to session initiation protocol, or a signaling standard primarily used for initiation and termination of digital voice or video calls.

As used herein, “SOAP” refers to simple object access protocol, or an information exchange protocol specific to Internet based services.

As used herein, “UDP” refers to user datagram protocol, established and known in the industry.

As used herein, “USB” refers to universal serial bus, an established set of industry standards governing physical interconnections for Internet accessing or computing devices.

As used herein, “VLAN” refers to a virtual local area network, or a means of network segmentation of digital data often separating Ethernet traffic.

The unique attributes of the novel countersurveillance system are presented in detailed embodiments below. Chiefly, the Ethernet based apparatus described in this application is designed to enable any user of a networked device, irrespective of technical and information systems sophistication, to determine whether uninitiated and undesired activity is occurring on the user's respective network. The embodiments below are presented as designed or tested illustrations only, and are not meant to limit the apparatus from extension to alternative, similar embodiments.

In an exemplary embodiment, a novel VoIP telephone monitoring device 100 is presented. The performance and security benefits of the unique device are accomplished by introducing into a passively connected electrical box a means for detecting audio and video data transmissions and registering such activity on an externally visible green/red indicator light 110, thereby allowing a proximate network user, such as a company employee, to recognize a potential security breach.

When connected to a VoIP phone 200, the novel device 100 provides continuous monitoring of voice traffic by analyzing traffic in each direction between the phone 200 and a private branch exchange (PBX) 300. When the phone is not in use, a green light indicates a lack of data exchange between the phone 200 and PBX 300. When the device detects voice traffic, the indicator light 110 emits a red color. A proximate user of the phone system will thus be alerted to unauthorized transfer of data if the red light is activated while the phone is in its passive, on-hook position. In other words, when an individual is not using his or her phone 200, there should be no RTP data exchanged by the phone with any third party through the PBX 300, other than routine exchange identifying the existence, operability, and/or connectivity between the phone and PBX.

The red/green indicator 110 may be solidly attached to or manufactured into the device. Alternatively, the indicator 110 may be one that is connected by Ethernet, USB, or similar means to the device, and is thus extendable to a position of high visibility by the phone user, such as a computer mounted position.

The present device is presented as a rectangular box with hard casing. The front of the device features inputs, while with opposite, rear side ports for Ethernet connectivity and a power adaptor, unless otherwise passively powered through the Ethernet feed-through. The casing may consist of plastic, metal, or any other durable material well suited to protect internal electronics from damage and dust. Device connectivity inputs may accommodate USB, HDMI, or any commonly used data transfer mechanisms.

Housed within the box are an Ethernet physical layer receiver, and processor unit coupled to a memory device. In a first embodiment, a TI SubArctic AM335x processor is utilized with a Micrel KSZ9031 GB Ethernet PHY transceiver. A number of alternative processors and receivers exist, such as other manufactures of Ethernet PHY. As optical fiber and Ethernet over Coax (EoC) cable becomes affordable for LAN and Internet-of-Things (IoT) applications, respective compatible processors and receivers can be substituted for the PHY technologies used in this first embodiment.

The embedded receiver is configured to sense VLAN packets exchanged between the VoIP phone and its router, switch, hub or PBX. The coupled processor is programmed to receive and determine packet types for a plurality of packets sensed by the receiver, further determine the presence of VoIP traffic based upon the screened packet types, and activate the red/green indicator, causing a change in coloration or other visual indicator such as a blinking light, based upon a determination of the existence of VoIP traffic.

The device may be considered an active or passive tap. In a first embodiment, an active tap is featured allowing a single interface into the processor for monitoring traffic in both directions.

The indicator of the first embodiment consists of an Ethernet connected red/green indicator. The indicator could alternatively consist of a visual indicator, red/green or otherwise, wirelessly connected to the box. An effective indicator may be supplemented by, or alternatively register the presence of VoIP traffic through audio alert, for example as an embedded speaker in the device.

In addition to the yes/no surveillance features of the present invention, the processor could be programmed to identify one or more of RTP, SOAP over TCP, SIP, or UDP packets sensed by the adjoining receiver. Information encoded within the packets could be registered as audio or video traffic, extracted and stored within a memory device. Specifically, the processor unit may record the time, length, origination, and destination of the packets on an internal or external memory system.

I claim:

1) A system for detecting undesirable audio and video data transfers comprising:
a VoIP telephone;
an Ethernet port;
an intermediary device connecting said telephone with said port; and,
a means for visibly detecting the transfer of data between said telephone and said port.

2) The system of claim 1, wherein the means for detecting the transfer of data is attached to said intermediary device.

3) The system of claim 1, wherein the means for detecting the transfer of data is a red/green indicator light.

4) The system of claim 1, wherein the intermediary device contains a processor and transceiver.

5) The system of claim 1, wherein the intermediary device contains a processor and transceiver, and activates a red/green indicator light external to the device in the presence of VLAN packet data transfer.

6) An apparatus for detecting undesired data transfer, comprising:
a hard casing exterior;
an interior processor;
an interior transceiver;
at least two Ethernet ports situated through the external shell;
a power adapter; and,
a means for visibly demonstrating an active data transfer exterior to the apparatus.

7) The apparatus of claim 6, wherein the means for visibly demonstrating an active data transfer consists of a lighting element.

8) The apparatus of claim 6, wherein the means for visibly demonstrating an active data transfer consists of a red/green indicator light.

9) A method for detecting undesired data transfer comprising:
Connecting a VoIP telephone to an intermediary device with a red/green indicator light by means of an Ethernet cable;
Connecting said intermediary device to a PBX exchange by means of an Ethernet cable; and, Monitoring said indicator light for a change in color when said phone is not in use.

10) The method of claim 9, wherein said intermediary device further comprises a processor and transceiver.

11) The method of claim 9, wherein said intermediary device further comprises:
a transceiver that is configured to sense VLAN packets exchanged between said phone and said PBX exchange; and
a processor programmed to receive and determine packet types for a plurality of packets sensed by the transceiver, further determine the presence of VoIP traffic based upon the screened packet types, and activate the red/green indicator.
